(19) United States
(12) Patent Application Publication
(10) Pub. No.: US 2022/0371132 A1
(43) Pub. Date: Nov. 24, 2022

(54) MACHINE ARRANGEMENT AND MECHANICAL METHOD FOR MANUFACTURING SHEET METAL

(71) Applicant: TRUMPF Werkzeugmaschinen SE + Co. KG, Ditzingen (DE)

(72) Inventor: Simon Ockenfuss, Renningen (DE)

(21) Appl. No.: 17/879,870

(22) Filed: Aug. 3, 2022

Related U.S. Application Data
(63) Continuation of application No. PCT/EP2021/052502, filed on Feb. 3, 2021.

(30) Foreign Application Priority Data
Feb. 7, 2020 (DE) 10 2020 103 183.1

(51) Int. Cl. B23K 37/04; B23K 26/38

(52) U.S. Cl. CPC B23K 37/0408; B23K 26/38

(57) ABSTRACT

A machine arrangement for manufacturing sheet metal includes a workpiece carrier configured to store a sheet metal workpiece and/or a sheet metal manufacturing product, and three spatially separate functional units. The functional units include two manufacturing units and a secondary functional unit. Each manufacturing unit includes a manufacturing apparatus that has a work area. The workpiece carrier is arrangeable in the work area in a manufacturing position. The secondary functional unit has a functional area. The workpiece carrier is arrangeable in the functional area in a functional position. The machine arrangement further includes a transporting unit movable in a driven manner together with the workpiece carrier between the functional units, thereby enabling the workpiece carrier to be transferred between the functional units. The workpiece carrier is a universal workpiece carrier arrangeable at the two manufacturing units in the manufacturing position and at the secondary functional unit in the functional position.

### CROSS REFERENCE TO RELATED APPLICATIONS

This application is a continuation of International Application No. PCT/EP2021/052502 (WO 2021/156284 A1), filed on Feb. 3, 2021, and claims benefit to German Patent Application No. DE 10 2020 103 183.1, filed on Feb. 7, 2020. The aforementioned applications are hereby incorporated by reference herein.

### FIELD

Embodiments of the present invention relate to a machine arrangement for manufacturing sheet metal, and a mechanical method for manufacturing sheet metal.

### BACKGROUND

A machine arrangement of a generic kind and a mechanical method of a generic kind are disclosed in EP 1 930 119 A1.

The prior art relates to a machine arrangement which is designed to cut sheet metal by means of a laser and comprises two laser cutting machines as manufacturing units and a store common to the two laser cutting machines as secondary functional unit. Each of the laser cutting machines has a work area which is provided with an enclosure and to which a pallet, which was loaded beforehand with sheet metal to be machined, is fed as workpiece carrier for the purpose of machining sheet metal. The pallet loaded with the sheet metal to be machined is arranged in the work area of the laser cutting machine in a defined machining position and the sheet metal is subjected to separating machining in the work area of the laser cutting machine on the pallet arranged in the machining position. After the machining has finished, the pallet of the laser cutting machine with the sheet metal machining product stored thereon is discharged from the work area of the laser cutting machine in question and moved into a handling position at the store of the machine arrangement. In the handling position, the sheet metal machining product is unloaded from the pallet of the laser cutting machine by means of a handling apparatus provided for this purpose and the sheet metal machining product is transferred to a store-side pallet. Depending on the usage situation, the store-side pallet with the sheet metal machining product deposited thereon is placed into storage in the store, moved to an outlet of the store, or transferred into a handling position located closer to the further laser cutting machine by means of a transfer unit that can be moved on the store, in which handling position a further handling apparatus transfers the sheet metal machining product from the store-side pallet to the pallet of the further laser cutting machine to carry out subsequent machining.

### SUMMARY

Embodiments of the present invention provide a machine arrangement for manufacturing sheet metal. The machine arrangement includes a workpiece carrier configured to store a sheet metal workpiece and/or to store a sheet metal manufacturing product, and three spatially separate functional units. The functional units include two manufacturing units and a secondary functional unit. Each manufacturing unit includes a manufacturing apparatus configured to manufacture the sheet metal and has a work area. The workpiece carrier is arrangeable in the work area in a manufacturing position. The sheet metal workpiece is accessible by the manufacturing apparatus to manufacture the sheet metal. The secondary functional unit is not configured to manufacture the sheet metal and has a functional area. The workpiece carrier is arrangeable in the functional area in a functional position. The machine arrangement further includes a transporting unit movable in a driven manner together with the workpiece carrier between the functional units, thereby enabling the workpiece carrier to be transferred between the functional units by the transporting unit. The workpiece carrier is a universal workpiece carrier arrangeable at the two manufacturing units in the manufacturing position and at the secondary functional unit in the functional position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows an assembly of manufacturing units and secondary functional units for use as functional units of a machine arrangement for manufacturing sheet metal according to embodiments of the present invention;

FIG. 1b shows a plan view of the manufacturing units and secondary functional units according to FIG. 1a according to embodiments of the present invention;

FIG. 1c shows an enlarged illustration of the detail D1 in FIG. 1b according to embodiments of the present invention;

FIG. 1d shows an enlarged illustration of the detail D2 in FIG. 1b according to embodiments of the present invention;

FIG. 1e shows a workpiece pallet as universal workpiece carrier of a machine arrangement for manufacturing sheet metal according to embodiments of the present invention;

FIGS. 2a, 2b, 2c, 2d, and 2e show a machine arrangement of a first type for manufacturing sheet metal according to embodiments of the present invention;

FIGS. 3a, 3b, 3c, 3d, 3e, and 3f show a machine arrangement of a second type for manufacturing sheet metal according to embodiments of the present invention;

FIG. 3g shows an enlarged illustration of the detail D3 in 3f according to embodiments of the present invention;

FIG. 4 shows a machine arrangement of a third type for manufacturing sheet metal according to embodiments of the present invention;

FIGS. 5a, 5b, 5c, 5d, and 5e show a machine arrangement of a fourth type for manufacturing sheet metal according to embodiments of the present invention;

FIGS. 6a, and 6b show a machine arrangement of a fifth type for manufacturing sheet metal according to embodiments of the present invention;

FIG. 7 shows a machine arrangement of a sixth type for manufacturing sheet metal according to embodiments of the present invention;

FIG. 8 shows a machine arrangement of a seventh type for manufacturing sheet metal according to embodiments of the present invention;

FIG. 9 shows a machine arrangement of an eighth type for manufacturing sheet metal according to embodiments of the present invention; and

FIGS. 10a, 10b, 10c, and 10d show a machine arrangement of a ninth type for manufacturing sheet metal according to embodiments of the present invention.

### DETAILED DESCRIPTION

Embodiments of the present invention provide a machine arrangement for manufacturing sheet metal,

having a workpiece carrier, which is designed to store a sheet metal workpiece and/or to store a sheet metal manufacturing product,

having three spatially separate functional units,

wherein, as functional units of the machine arrangement, two manufacturing units and, in addition to the manufacturing units, a secondary functional unit are provided, wherein the two manufacturing units are provided for manufacturing sheet metal and each comprise a manufacturing apparatus for manufacturing sheet metal having a work area, in which a workpiece carrier can be arranged in a manufacturing position and in which a sheet metal workpiece, stored by a workpiece carrier arranged in the manufacturing position, can be accessed by the manufacturing apparatus to manufacture sheet metal, and

wherein the secondary functional unit is not provided for manufacturing sheet metal and has a functional area, in which the workpiece carrier can be arranged in a functional position,

and also

having a transporting unit, which can be moved in a driven manner together with the workpiece carrier between functional units of the machine arrangement and by means of which functional units can be interconnected in that the workpiece carrier can be transferred between functional units by means of the transporting unit.

Embodiments of the present invention furthermore relate to a mechanical method for manufacturing sheet metal, in the course of which a transporting unit having a workpiece carrier, which is designed to store a sheet metal workpiece and/or to store a sheet metal manufacturing product, is moved in a driven manner between spatially separate functional units of a machine arrangement for manufacturing sheet metal and transfers the workpiece carrier between functional units resulting in the functional units being interconnected,

wherein, as functional units of the machine arrangement for manufacturing sheet metal, two manufacturing units and, in addition to the manufacturing units, a secondary functional unit are provided,

wherein the two manufacturing units are provided for manufacturing sheet metal and each comprise a manufacturing apparatus for manufacturing sheet metal having a work area, in which a workpiece carrier can be arranged in a manufacturing position and in which a sheet metal workpiece, stored by a workpiece carrier arranged in the manufacturing position, can be accessed by the manufacturing apparatus for the purpose of manufacturing sheet metal, and

wherein the secondary functional unit is not provided for manufacturing sheet metal and has a functional area, in which the workpiece carrier can be arranged in a functional position.

According to embodiments of the invention, a distinction is made between manufacturing unit and secondary functional unit. A manufacturing unit is provided for manufacturing sheet metal, that is to say for example for cutting, punching, bending, boring, forming threads in, welding, shaping etc. sheet metal. A secondary functional unit is not provided for manufacturing sheet metal, and may therefore be e.g. a sorting station, a cleaning installation, a loading or unloading station, a quality checking station, a store or the like.

In some embodiments, a universal workpiece carrier, which can be used at all functional units of the machine arrangement according to the invention, is provided as workpiece carrier. On a machine arrangement according to the invention, it is possible to use an individual universal workpiece carrier but also, in particular at the same time, to use multiple universal workpiece carriers.

The transporting unit of the machine arrangement according to the invention interconnects different functional units in that the transporting unit transfers the universal workpiece carrier to different functional units. At the manufacturing units of the machine arrangement according to the invention, it is possible for the transporting unit to arrange the universal workpiece carrier indirectly or directly in the manufacturing position; at the secondary functional unit of the machine arrangement according to the invention, the transporting unit can transfer the universal workpiece carrier indirectly or directly into the functional position.

Within the meaning of the invention, a transporting unit means an apparatus designed to transport the workpiece carrier and the sheet metal workpieces and/or sheet metal manufacturing products that are stored by the workpiece carrier. This can be done in different ways, e.g. on a carriage, on belts, on cables, on the ground, through the air, on predefined paths or freely in space. In particular, the transporting apparatus may be motorized.

In a preferred embodiment of the invention, the transporting unit directly arranges the universal workpiece carrier in the manufacturing position and/or in the functional position at least at some of the functional units of the machine arrangement according to the invention. This is necessary in cases where the universal workpiece carrier is fixedly mounted on the transporting unit and optional when the universal workpiece carrier is detachably connected to the transporting unit.

Interconnection of the functional units by way of the transporting unit and the universal workpiece carrier moved by means of the transporting unit is possible on the machine arrangement according to the invention with any desired mutual assignment of the functional units. In this respect, it is possible for all or only some of the functional units of a machine arrangement to be interconnected.

On account of the universal nature of the workpiece carrier, there is little handling of sheet metal workpieces and/or sheet metal manufacturing products on the machine arrangement according to the invention and in the course of the mechanical method according to the invention. One and the same transporting unit charges multiple functional units of the machine arrangement according to the invention with one and the same workpiece carrier. The outlay on apparatus required on the machine arrangement according to the invention to realize the material flow is correspondingly low. The mechanical method according to the invention is distinguished in particular by short cycle times owing to the relatively low number of handling operations.

In some embodiments, a sheet metal pallet may be provided as universal workpiece carrier. In particular, it may comprise a pallet frame. In particular, supporting elements for sheet metal workpieces and/or for sheet metal manufacturing products may be arranged within the pallet frame, preferably supporting elements in the form of supporting bars arranged mutually spaced apart within the pallet frame. A universal workpiece carrier of this kind is used in particular in cases where stationary sheet metal is machined by means of a laser at least at one of the manufacturing units of the machine arrangement according to the invention.

A plate-like workpiece support likewise comes into consideration as universal workpiece carrier of the machine arrangement according to the invention. In particular, it may comprise supporting elements for storing sheet metal workpieces and/or sheet metal manufacturing products, preferably supporting elements in the form of brushes and/or rollers and/or balls. A universal workpiece carrier of this type can be recommended in particular for a machine arrangement according to the invention having at least one manufacturing unit, at which, for machining purposes, a sheet metal workpiece is to be moved by way of the universal workpiece carrier arranged in the manufacturing position. This may be the case, for instance, on a manufacturing unit for the shaping of or on a manufacturing unit for the punching and/or laser machining of sheet metal workpieces.

In a preferred embodiment of the machine arrangement according to the invention, all essential functions are numerically controlled.

According to some embodiments, the universal workpiece carrier can be transferred between at least one of the manufacturing units, on the one hand, and the secondary functional unit, on the other hand, by means of the transporting unit of the machine arrangement according to the invention. One and the same secondary functional unit may accordingly be interconnected with a single manufacturing unit, or else with multiple manufacturing units.

According to some embodiments, the machine arrangement has more than two manufacturing units. It is conceivable for the universal workpiece carrier not to be arrangeable in the manufacturing position at the further manufacturing unit, or—in the case of multiple further manufacturing units—at least at one of the further manufacturing units. According to the invention, it is also possible to interconnect further manufacturing units, at which the universal workpiece carrier is not arrangeable in the manufacturing position, with other functional units of the machine arrangement in question by means of the transporting unit and the universal workpiece pallet. At the further manufacturing unit not suitable for the universal workpiece pallet, it is necessary to transfer sheet metal workpieces and/or sheet metal manufacturing products between the universal workpiece pallet and the work area of the manufacturing apparatus.

However, the universal workpiece carrier may also be arrangeable in the manufacturing position at the or at least at some of the further manufacturing units.

In a preferred configuration of the invention, each one or some of the more than two manufacturing units can be interconnected with the secondary functional unit by the transporting unit and the universal workpiece pallet.

In a further advantageous configuration of the invention, the machine arrangement according to the invention comprises a plurality of secondary functional units. Accordingly, on a machine arrangement of this kind, as functional units, at least two manufacturing units and at least two secondary functional units are provided, between which the universal workpiece carrier can be transferred by means of the transporting unit. In principle, it is also possible for all or some of the functional units of this invention type to be interconnected with any desired mutual assignment by means of the transporting unit and the universal workpiece carrier.

In a manner corresponding to the relationships in the case of one or more further manufacturing units, it is possible that the or at least one of the further secondary functional units is not suitable for the arrangement of the universal workpiece carrier in a functional position. On a further secondary functional unit of this kind, it is necessary to transfer sheet metal workpieces and/or sheet metal manufacturing products between the universal workpiece carrier and the functional area of the secondary functional unit.

According to some embodiments, the universal workpiece carrier can also be arranged in the functional position at the or at least at one of the further secondary functional units.

According to some embodiments, multiple, preferably all the manufacturing units of the machine arrangement according to the invention are interconnected by the transporting unit and the universal workpiece carrier transferred by means of the transporting unit. Manufacturing units can be interconnected in this way in the case of machine arrangements with two manufacturing units and also on machine arrangements with more than two manufacturing units.

According to some embodiments, provision is made for multiple, preferably all of the secondary functional units to be interconnected by means of the transporting unit and the universal workpiece carrier.

According to some embodiments, provision is made for the universal workpiece carrier to be transferable between at least one of the two or more manufacturing units, on the one hand, and at least one of the at least two secondary functional units, on the other hand, by means of the transporting unit. In particular, the universal workpiece carrier can be transferable between each one of the at least two manufacturing units, on the one hand, and each one of the at least two secondary functional units, on the other hand, by means of the transporting unit.

Due to corresponding design precautions, the universal workpiece carrier can be arrangeable at the manufacturing unit in question and/or at the secondary functional unit in question directly in the manufacturing position or in the functional position, respectively, by means of the transporting unit.

As a departure from this, in some embodiments, provision is made for the universal workpiece carrier to be transferred by the transporting unit to a secondary functional unit in the form of a charging unit, which is assigned to a manufacturing unit of the machine arrangement and by means of which the universal workpiece carrier can be transferred from a position outside the work area of the manufacturing unit into the manufacturing position. A conventional pallet changer comes into consideration as charging unit, for example, as is common for the purpose of charging the work area of laser machining machines with workpieces stored on pallets.

On a loading unit of the machine arrangement according to the invention, the universal workpiece carrier is loaded in a manual or automated manner in particular with a sheet metal workpiece that is to undergo a manufacturing operation. After the loading operation, by means of the transporting unit each or some of the further functional units of the machine arrangement can be charged with the universal workpiece carrier and the sheet metal workpiece stored thereby. In particular, there is the option of utilizing an individual loading unit for multiple manufacturing units. An unloading unit of the machine arrangement according to the invention can be operated correspondingly. The universal workpiece carrier can be placed into storage in the laden or unladen state in a storage unit of the machine arrangement according to the invention. It is conceivable, for example, to temporarily store the universal workpiece carrier, that was loaded with products of a first manufacturing operation after being transferred to a manufacturing unit, in the store, before the laden universal workpiece carrier, for the purpose of carrying out a subsequent operation, is removed from storage and transferred to a further manufacturing unit of the machine arrangement. A store-side handling unit having a handling position as functional position of the universal workpiece carrier can be used to place the universal workpiece carrier into storage and remove it therefrom. At a cleaning unit of the machine arrangement according to the invention, the universal workpiece carrier is cleaned, in particular to remove manufacturing-related impurities. At the cleaning station it is possible to remove machining-related caked-on deposits, for instance slag formed when the sheet metal undergoes thermal machining, manually or by means of corresponding mechanical aids, for example from supporting bars of workpiece pallets, as are used to store sheet metal during the laser machining. It is possible, for instance on a universal workpiece pallet of the latter kind, to exchange supporting bars for maintenance purposes or carry out necessary repair work at a maintenance and/or repair unit of the machine arrangement according to the invention. The universal workpiece carrier is configured for a subsequent operation, in particular for a subsequent manufacturing operation, at an equipping unit of the machine arrangement according to the invention. To configure a universal workpiece pallet for the laser machining of sheet metal, for instance, it is possible to charge a pallet frame with supporting bars in a manner coordinated with the subsequent machining. In this respect, for example, the geometry and the mutual spacing between the supporting bars used can be selected with respect to the specific usage situation. A supply unit serves to hold one or more universal workpiece carriers available as a reserve within the machine arrangement according to the invention. A process preparation unit of the machine arrangement according to the invention may be designed in particular to prepare a subsequent manufacturing operation. It is conceivable, for example, to create a workpiece format suitable for the subsequent manufacturing operation, to preparatorily clean the sheet metal workpiece that is to undergo the manufacturing operation, and/or to apply markings to a sheet metal workpiece in order to allow the workpiece to be tracked in the subsequent manufacturing process. A process follow-up unit of the machine arrangement according to the invention serves in particular to follow up on manufacturing operations. There is the option, for example, for sheet metal parts present at a process follow-up unit as products of the cutting machining of sheet metal to be cleaned by blowing off or brushing off loose impurities or to be deburred by means of a corresponding mechanical apparatus.

According to some embodiments, a floor conveyor, in particular a forklift truck, comes into consideration as freely movable transporting unit, for example. The driverless transport vehicle provided according to the invention may be provided with an active or a passive load receiving means.

On the machine arrangement according to the invention, the universal workpiece carrier may be fixedly connected to the transporting unit. In the case of invention types of this kind, the universal workpiece carrier is transferred by means of the transporting unit of the machine arrangement directly into the manufacturing and functional position(s), in which the universal workpiece carrier remains connected to the transporting unit in the course of any operations that may take place.

According to some embodiments, a detachable connection is provided between the transporting unit and the universal workpiece carrier. Owing to the detachable connection, the universal workpiece carrier can be separated from the transporting unit before or after being transferred into the manufacturing position or into the functional position. During a subsequent operation on the universal workpiece carrier or on sheet metal workpieces or manufacturing products that are stored by the universal workpiece carrier, the transporting unit can then assume a position away from the functional unit in question, in which position the transporting unit is protected against any damaging influences on account of the operation carried out on the universal workpiece carrier or its load. There is also the option of utilizing the transporting unit to carry out other transfers of workpiece carriers within the machine arrangement according to the invention during the operation that follows the transfer of the universal workpiece carrier into the manufacturing position or into the functional position.

In particular for automated sheet metal manufacturing processes, a defined and precisely reproducible position of sheet metal workpieces to be machined and/or of sheet metal manufacturing products in the coordinate system of the process controller is of decisive importance. Against this background, in a further preferred embodiment of the invention precautions for a defined arrangement of the universal workpiece carrier on the transporting unit are made on the transporting unit and/or on the universal workpiece carrier.

Irrespective of whether the universal workpiece carrier is connected detachably or fixedly to the transporting unit, it is necessary for sheet metal workpieces stored by the universal workpiece carrier and/or manufacturing products stored by the universal workpiece carrier to assume a defined and precisely reproducible position at the manufacturing unit(s) of the machine arrangement according to the invention and at the secondary functional unit(s) of the machine arrangement according to the invention, in order for the operation in question to be able to give the desired result. After the position of the sheet metal workpieces and also the position of the manufacturing products has been determined directly by the position assumed by the universal workpiece carrier in the manufacturing or functional position, corresponding positioning devices are provided in the work area and/or in the functional area of manufacturing units or of secondary functional units of the machine arrangement according to the invention. In addition or alternatively, the universal workpiece carrier of the machine arrangement according to the invention may comprise positioning devices of the stated kind.

Manufacturing units of the kind according to the invention serve to carry out manufacturing operations on sheet metal, with the generic term “manufacturing” being intended generally to cover primary shaping, shaping, separating, joining and coating. In the case of the invention, as laser manufacturing units particular consideration is given to laser cutting units, laser welding units and laser marking or laser inscribing units. Shaping units of the machine arrangement according to the invention are designed in particular to bend sheet metal workpieces. Separating units according to the invention may be in the form of punching units or laser separating units, for example. The machine arrangement according to the invention may comprise a welding unit, for example, as joining unit. In the case of the invention, as coating units consideration is given to lacquering and inscribing units, for example.

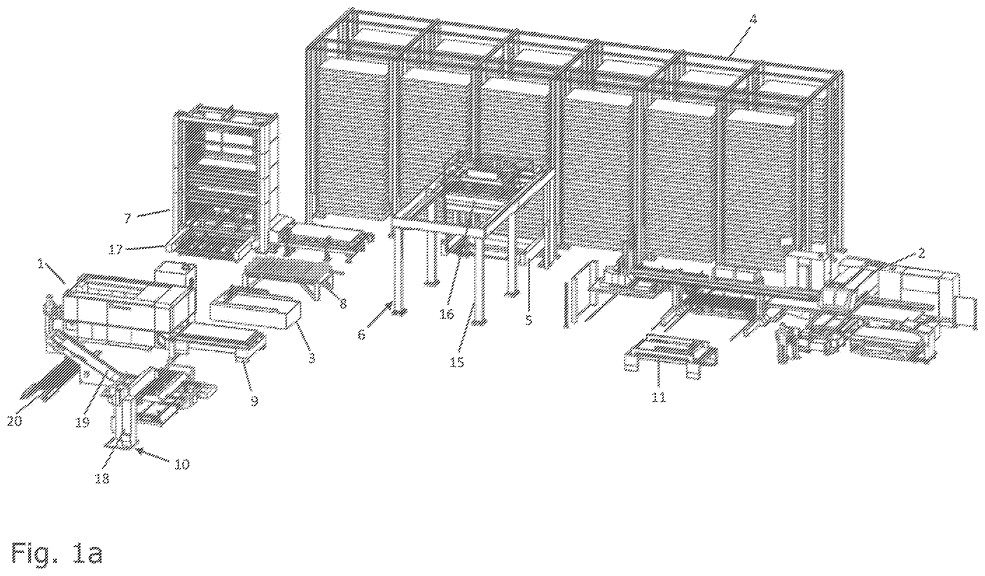

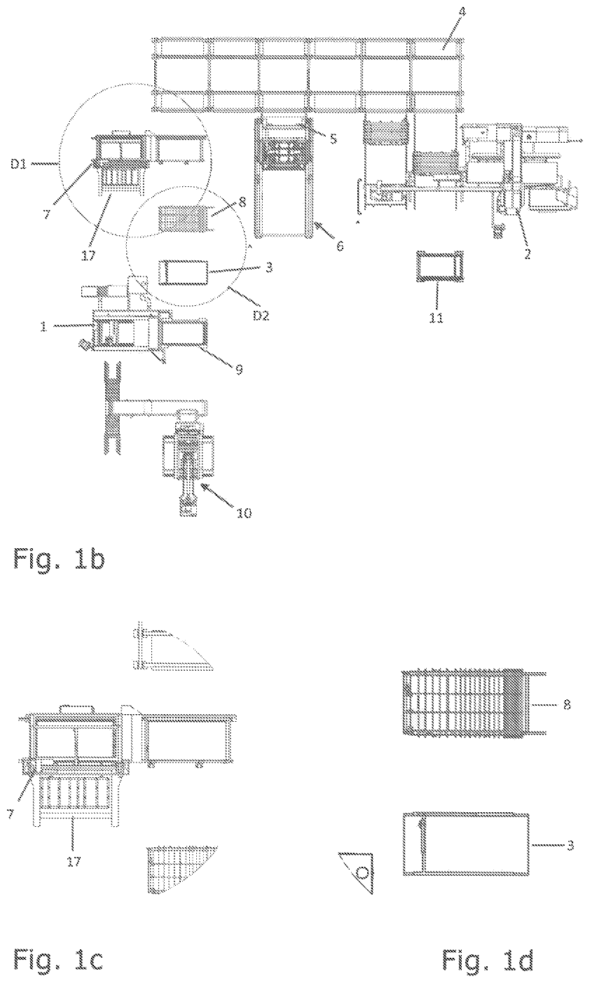

FIGS. 1a and 1b illustrate examples of functional units that come into consideration as components of a machine arrangement for manufacturing sheet metal. The functional units illustrated are potential manufacturing units, on the one hand, and potential secondary functional units, on the other hand, of a machine arrangement for manufacturing sheet metal.

As examples of manufacturing units, FIGS. 1a and 1b show separating units for the separating machining of sheet metal in the form of a laser flatbed machine 1 and in the form of a combined punching and laser machine 2 and also a coating unit 3 for manufacturing sheet metal. The punching station of the combined punching and laser machine 2 is a conventional press with a punching tool as manufacturing apparatus. By exchanging the punching tool for a shaping tool, the combined punching and laser machine 2 can be retrofitted to give a manufacturing unit in the form of a combined shaping and laser machine.

The examples illustrated in FIGS. 1a and 1b for secondary functional units are, in detail, a storage unit in the form of a material store 4, a store-side storage and retrieval machine 5 that can be used as store-side handling unit, a loading unit 6, a supply unit in the form of a pallet supply store 7, a pallet servicing unit 8 that can be used as equipping unit, as maintenance and repair unit and also as cleaning unit, a charging unit that is provided for the laser flatbed machine 1 and is in the form of a pallet changer 9, an unloading unit 10, and a deburring unit 11 that can be used as process follow-up unit.

As further manufacturing units for manufacturing sheet metal that are not illustrated in FIGS. 1a and 1b, consideration is given for example to a bending press as shaping unit, and a joining unit, it being possible for the joining unit to be in the form of a laser welding machine, for example.

Manufacturing units and secondary functional units of the kind shown in FIGS. 1a and 1b can be combined, depending on the manufacturing process(es) to be carried out, in different numbers and in different compositions to form a machine arrangement for manufacturing sheet metal.

A common feature of all machine arrangements composed of functional units of the kind shown in FIGS. 1a and 1b is that the respective functional units are interconnected by a transporting unit and by a workpiece pallet 12 that is transferred between functional units of the respective machine arrangement by means of the transporting unit (FIG. 1e).

The workpiece pallet 12 forms a universal workpiece carrier and as such can be arranged in a manufacturing position at least at two, preferably at all manufacturing units of the machine arrangement in question and, additionally, in a functional position at least at one functional unit, or, when multiple secondary functional units are used, preferably at all secondary functional units of the machine arrangement.

The structural configuration of the workpiece pallet 12 in particular depends on the kind of manufacturing operations to be carried out on a machine arrangement. For instance, for the laser machining of sheet metal workpieces, which are stationary during the machining, use may be made of workpiece pallets 12 of the conventional type with a pallet frame and with workpiece supporting bars, which are mounted preferably detachably on the pallet frame to form a workpiece support. A workpiece pallet 12 of this type is illustrated by way of example in FIG. 1e.

In cases where manufacturing operations in which a sheet metal workpiece must be moved relative to a manufacturing apparatus by way of a workpiece pallet 12 are to be carried out on the sheet metal workpiece stored on the workpiece pallet 12, preference can be given to a workpiece pallet 12 that allows sheet metal workpieces to be moved without scratching them. Conceivable for usage situations of this kind is a workpiece support 12 provided on a pallet frame with a plate-like workpiece support, which for its part has supporting elements in the form of supporting brushes and/or supporting balls and/or supporting rollers for the purpose of storing sheet metal workpieces.

The transfer of the workpiece pallet 12 to the at least two manufacturing units and to the at least one secondary functional unit of a machine arrangement, composed of the functional units of FIGS. 1a and 1b, for manufacturing sheet metal is undertaken by the transporting unit of the machine arrangement in question. In this respect, the at least two manufacturing units and the at least one secondary functional unit of the machine arrangement can be interconnected with any desired mutual assignment by the transporting unit and the workpiece pallet 12 transferred by means of the transporting unit.

As transporting units, consideration is given to freely movable, but also rail-bound apparatuses, for example manned forklift trucks, driverless transport vehicles (“FTV”, “Automated guided vehicles”/“AGV”) and/or rail-bound floor conveyors. Transporting units are not illustrated in FIGS. 1a and 1b for the sake of clarity.

If the workpiece pallet 12 assumes the manufacturing position at a manufacturing unit, a sheet metal workpiece stored by the workpiece pallet 12 can be accessed in a work area of the manufacturing unit by a manufacturing apparatus provided there for the purpose of manufacturing sheet metal. For instance, at the laser flatbed machine 1, the work area of a laser cutting head, which can be moved along two axes in a horizontal plane and moreover can be advanced in a vertical direction, is located inside an enclosure in a known way.

In the work area of the laser cutting head of the laser flatbed machine 1, the workpiece pallet 12 loaded with a sheet metal workpiece to be machined can be transferred directly by the transporting unit of the machine arrangement in question after being transferred to the laser flatbed machine 1. After the machining of the workpiece has finished, in this case the workpiece pallet 12, which is then loaded with the sheet metal manufacturing product, is taken up directly by the transporting unit at the enclosure of the laser flatbed machine 1.

An alternative option is to move the workpiece pallet 12 by interposing a pallet changer 9 between the work area of the laser flatbed machine 1 and the transporting unit.

A workpiece pallet 12 that is loaded with a sheet metal workpiece to be machined and that is transferred to the pallet changer 9 by means of the transporting unit is transferred by the transporting unit to the pallet changer 9 for this purpose. Starting from a handling position, which is provided as functional position, specifically as charging position, at the pallet changer 9, the laden workpiece pallet 12 is then moved from the pallet changer 9 into the work area of the laser flatbed machine 1 and arranged there in the manufacturing position. The workpiece pallet 12, loaded with a sheet metal manufacturing product after the machining has ended, is conveyed from the work area of the laser flatbed machine 1 back into the handling position at the pallet changer 9 and transferred from there to the transporting unit.

To transfer the workpiece pallet 12 loaded with a sheet metal workpiece to be machined and/or to take up a workpiece pallet 12 loaded with a sheet metal manufacturing product, the transporting unit can be moved along to the pallet changer 9 or alternatively moved into it given a corresponding design of the pallet changer 9.

In the former case, the laden workpiece pallet 12 is moved by conventional conveying means, for example by means of a conventional chain drive, from the transporting unit into the handling position at the pallet changer 9, or from the handling position at the pallet changer 9 to the transporting unit.

If the transporting unit can move into the pallet changer 9, there is the option of transferring the workpiece pallet 12, which is loaded with a sheet metal workpiece to be machined, directly into the handling position at the pallet changer 9 by using the transporting unit to transfer the workpiece pallet 12 to the pallet changer 9. Correspondingly, a workpiece pallet 12 loaded with a sheet metal manufacturing product can be transferred directly to the transporting unit moved into the pallet changer 9 by moving said workpiece pallet from the manufacturing position at the laser flatbed machine 1 into the handling position at the pallet changer 9.

To charge the combined punching and laser machine 2 with a sheet metal workpiece to be machined, the transporting unit, together with the workpiece pallet 12 and the sheet metal workpiece stored thereby, is moved into a position in the direct vicinity of the machine table of the combined punching and laser machine 2. The sheet metal workpiece is then transferred from the workpiece pallet 12 onto the machine table by means of a conventional mechanical loading and unloading device, which is not illustrated in the figures. After the manufacturing operation on the combined punching and laser machine 2 has ended, the sheet metal manufacturing product is moved from the machine table of the combined punching and laser machine 2 onto the workpiece pallet 12 remaining on the transporting unit by means of the loading and unloading device.

The transfer of the workpiece pallet 12, loaded with a sheet metal workpiece to be machined, into the work area and the taking up of the workpiece pallet 12, loaded with a sheet metal manufacturing product, from the work area by the transporting unit optionally by way of a pallet changer 9 or directly, and consequently without interposing a pallet changer 9, also take place at the coating unit 3.

The workpiece pallet 12 can also be arranged in a functional position in a functional area at the material store 4, at the store-side storage and retrieval machine 5, at the loading unit 6, at the pallet supply store 7, at the pallet servicing unit 8, at the unloading unit 10 and at the deburring unit 11 by means of the transporting unit.

The transfer and taking up of the workpiece pallet 12 at the material store 4 can be effected directly between the transporting unit and a pallet storage location of the material store 4. After being placed into the store, the workpiece pallet 12 assumes a storage position as functional position at the storage location in question of the material store 4.

An alternative option is to transfer the workpiece pallet 12 between the transporting unit and the material store 4 by way of the store-side storage and retrieval machine 5, on which the workpiece pallet 12 assumes a handling position as functional position. When the workpiece pallet 12 on the storage and retrieval machine 5 is taken up by the transporting unit, the workpiece pallet 12 arranged on the storage and retrieval machine 5 in the handling position and removed from storage in the material store 4 beforehand by means of the storage and retrieval machine 5 is pushed by the storage and retrieval machine 5 onto the transporting unit by means of a transfer apparatus, provided on the storage and retrieval machine 5 in the usual way. A workpiece pallet 12 to be placed into storage in the material store 4 by way of the storage and retrieval machine 5 is first of all moved by the transporting unit into the handling position at the store-side storage and retrieval machine 5. Then, the storage and retrieval machine 5 moves the workpiece pallet 12 from the handling position to a free storage location on the material store 4. For this purpose, the storage and retrieval machine 5 can be moved along on the material store 4 in a horizontal and/or vertical direction. The storage and retrieval machine 5 arranged at the free storage location of the material store 4 pushes the workpiece pallet 12 into the free storage location on the material store 4 and as a result transfers it into the storage position.

The loading unit 6 is provided to load the workpiece pallet 12 with a sheet metal workpiece that is to undergo a manufacturing operation. In a known way, the loading unit 6 comprises a frame structure 15, on which a handling apparatus 16 provided with a vertically movable load-receiving means can move horizontally.

To load the workpiece pallet 12 with a sheet metal workpiece to be machined, the transporting unit together with the empty workpiece pallet 12 travels towards a loading position, provided as functional position, at the loading unit 6. The handling apparatus 16 is then moved, together with a sheet metal workpiece received beforehand by the handling apparatus 16, on the frame structure 15 in a horizontal direction into a position from which the sheet metal workpiece is deposited on the workpiece pallet 12 arranged in the loading position by lowering the load-receiving means of the handling apparatus 16. From the handling apparatus 16, a sheet metal workpiece to be transferred to the workpiece pallet 12 can be taken up for example from a stack of raw sheet metal arranged away from the loading position of the workpiece pallet 12. As indicated in FIG. 1a, the handling apparatus 16 of the loading unit 6 may also receive a sheet metal workpiece, that is intended for machining, at the store-side storage and retrieval machine 5. In this respect, it is possible for a storage pallet, removed beforehand from the material store 4, together with raw sheet metal to be arranged on the storage and retrieval machine 5 in a position accessible to the handling apparatus 16. There is also the option for the handling apparatus 16 of the loading unit 6 to access a stack of raw sheet metal, which is not shown, with which a storage carriage has been loaded beforehand by means of a storage and retrieval machine of the material store 4.

Workpiece pallets 12 are held available in the pallet supply store 7 for example for the case in which a workpiece pallet 12 previously used in the machine arrangement is temporarily unavailable on account of maintenance and/or repair work on the workpiece pallet 12, for instance, and/or for the case in which one or more additional workpiece pallets 12 are required in addition to a workpiece pallet 12 already circulating in the machine arrangement.

The workpiece pallet 12 assumes a supply position as functional position at the pallet supply store 7. To transfer the workpiece pallet 12 between the transporting unit and the pallet supply store 7, use is made of a storage and retrieval machine 17, to which a workpiece pallet 12 to be placed into storage at the pallet supply store 7 is transferred by the transporting unit and from which a workpiece pallet 12 previously removed from storage in the pallet supply store 7 is taken up by the transporting unit.

The pallet servicing unit 8 serves to configure the workpiece pallet 12 for an operation to be carried out, in particular for an upcoming manufacturing operation, and moreover also to maintain the functionality of the workpiece pallet 12.

To configure the workpiece pallet 12 for an upcoming operation, the pallet servicing unit 8 is used as equipping unit, at which the workpiece pallet 12 assumes an equipping position as functional position. In the equipping position, a pallet frame of the workpiece pallet 12 is provided with a workpiece support in a manner coordinated with the subsequent operation. When the workpiece pallet 12 is being used in the separating machining of sheet metal workpieces on the laser flatbed machine 1, for instance, the pallet frame of the workpiece pallet 12 at the pallet servicing unit 8 acting as equipping unit is charged with workpiece supporting bars, the geometry and arrangement on the pallet frame of which are coordinated with the separating process to be carried out. In this context, the supporting bars on the workpiece pallet 12 according to FIG. 1e have a non-uniform mutual spacing.

To maintain the functionality of the workpiece pallet 12, the pallet servicing unit 8 is used as maintenance and repair unit and/or as cleaning unit.

The workpiece pallet 12 assumes a maintenance and/or repair position as functional position at the pallet servicing unit 8 used as maintenance and repair unit. In the maintenance and/or repair position, on the workpiece pallet 12 damaged supporting bars, for example, for sheet metal workpieces are replaced by new supporting bars or damaged supporting bars are displaced back into a functional state by corresponding shaping, for instance.

As cleaning unit, the pallet servicing unit 8 may be provided with apparatuses for cleaning the workpiece support formed on the workpiece pallet 12. In the case of a workpiece pallet 12 with supporting bars, as cleaning apparatus consideration is given in particular to a manually or mechanically operated supporting bar cleaner of the conventional type. For cleaning purposes, a plate-like workpiece support of the workpiece pallet 12 may be manually or mechanically brushed or cleaned by being subjected to compressed air.

The unloading unit 10 is an automation component of the conventional type. Customarily, the unloading unit 10 comprises a column 18, which is rotatable about a vertical axis and on which is mounted a pivot arm 19 that can pivot about a horizontal axis. In the exemplary case illustrated in FIG. 1a, at the end remote from the column 18 the pivot arm 19 is provided with a grille-like receiving apparatus 20.

Given a corresponding configuration, the unloading unit 10 is used to remove all products of a previous manufacturing operation from a workpiece pallet 12 that had been transferred beforehand by the transporting unit of the machine arrangement in question into an unloading position provided as functional position. As a departure from this, it is also conceivable to configure the unloading unit 10 with an integrated sorting function. In this case, the unloading unit 10 is used for example to unload parts of acceptable quality, produced in the previous manufacturing operation, from the workpiece pallet 12 that was moved into the unloading position, while manufacturing waste, in the case of the cutting machining of sheet metal a residual cut-out sheet, for example, initially remains on the workpiece pallet 12 and is disposed of elsewhere after the parts of acceptable quality have been unloaded.

At the deburring unit 11, burr that formed during the manufacturing operation is manually or mechanically removed from products of a previous manufacturing operation, for example a sheet metal blank.

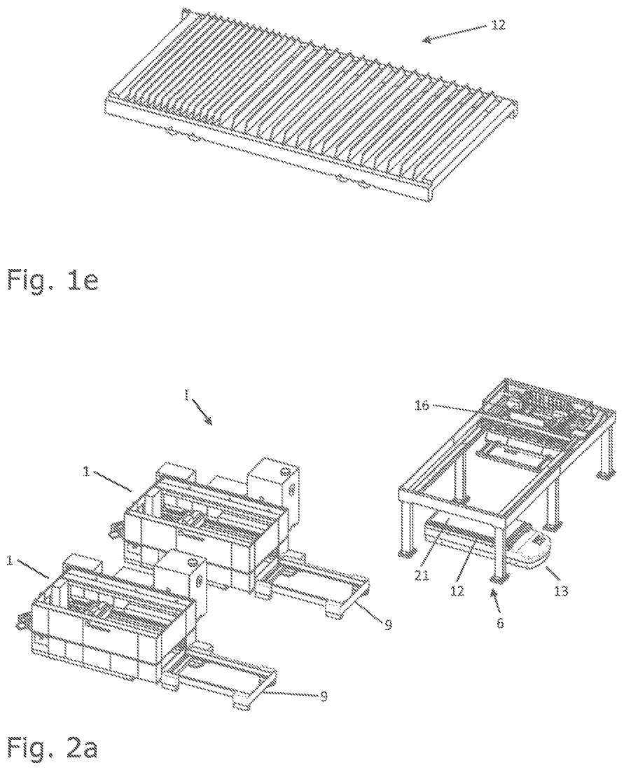

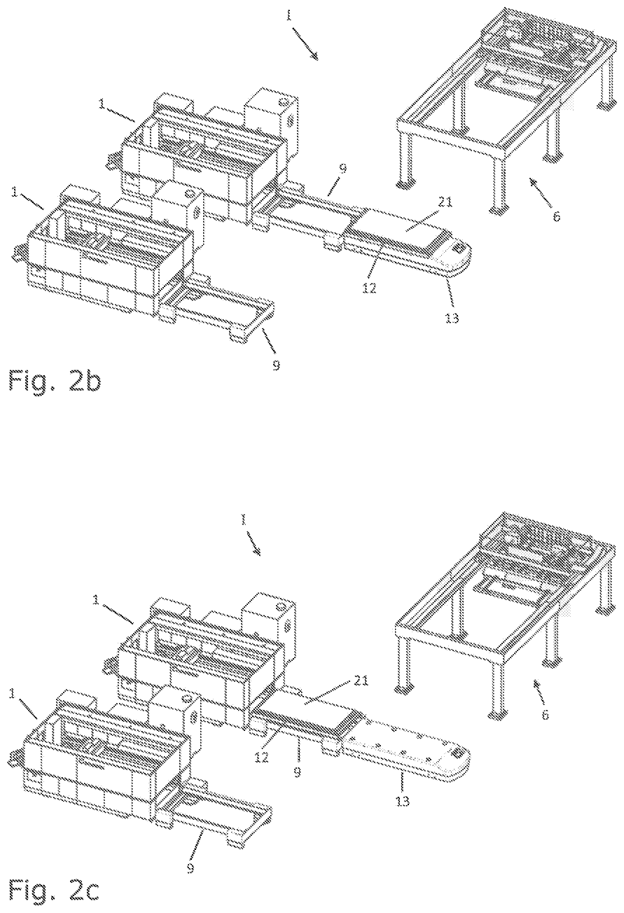

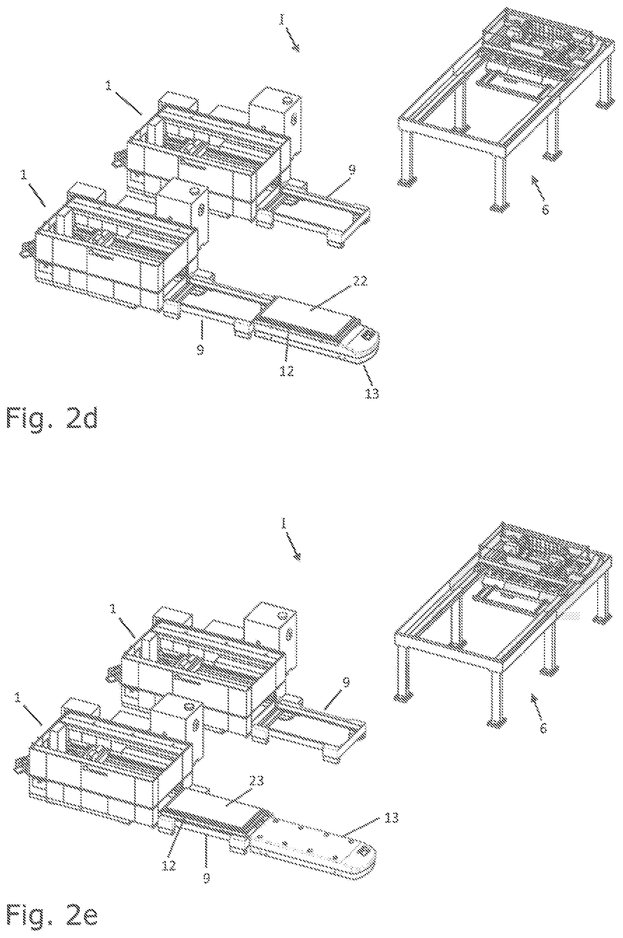

Examples of machine arrangements for manufacturing sheet metal that were configured using functional units of FIGS. 1a and 1b and examples for the interconnection of functional units of the kind illustrated in FIGS. 1a and 1b can be seen in FIGS. 2a to 10d.

A machine arrangement I, illustrated in FIGS. 2a to 2e, for manufacturing sheet metal comprises, as functional units, two manufacturing units and three secondary functional units. The manufacturing units of the machine arrangement I are two laser flatbed machines 1. A loading unit 6 and two pallet changers 9 are provided as secondary functional units. The functional units of the machine arrangement I are interconnected by means of a transporting unit in the form of a driverless transport vehicle/FTV 13, on which a workpiece pallet 12 used as universal workpiece carrier can be detachably mounted. Usually, in coordination with the separating laser machining to be carried out on the machine arrangement I, the workpiece pallet 12 has a pallet frame with supporting bars, which run parallel to one another, mutually spaced apart, on the pallet frame to form a workpiece support.

FIG. 2a shows the machine arrangement I after the workpiece pallet 12 arranged on the FTV 13 has been laden by the loading unit 6. The loading unit 6 was used to deposit raw sheet metal 21 as sheet metal workpiece on the workpiece pallet 12 that was moved directly into the loading position at the loading unit 6 by the FTV 13. Prior to this, the raw sheet metal 21 had been received by the handling apparatus 16 in the customary manner from a stack of raw sheet metal, which is not illustrated.

Taking the loading unit 6 as a starting point, the FTV 13 transfers the laden workpiece pallet 12 to the pallet changer 9 of the laser flatbed machine 1 that is at the top in the illustrations (FIG. 2b). The laden workpiece pallet 12 is now moved by the FTV 13 onto the pallet changer 9 and into the handling position there (FIG. 2c) by means of a mechanical apparatus of the conventional type, which is not shown in more detail, before the workpiece pallet 12 loaded with the raw sheet metal 21 is moved from the handling position at the top pallet changer 9 into the manufacturing position in the work area of the top laser flatbed machine 1 by means of a likewise conventional mechanical apparatus. In the work area of the laser flatbed machine 1, the separating machining of the raw sheet metal 21 is then carried out on the workpiece pallet 12 arranged in the manufacturing position.

Meanwhile, the FTV 13 can remain in the waiting position according to FIG. 2c. If the machine arrangement I has a pallet supply store 7, the FTV 13 may alternatively travel to the pallet supply store 7, receive a further workpiece pallet 12 there, and transfer the further workpiece pallet 12 from the pallet supply store 7 to the loading unit 6 and arrange it directly in the loading position there. In the manner described above, the FTV 13 can then transfer the further laden workpiece pallet 12 from the loading position at the loading unit 6 to the pallet changer 9 that is at the bottom in FIGS. 2a to 2e, from where the laden further workpiece pallet 12 can be moved into the work area of the bottom laser flatbed machine 1 for the purpose of separating machining.

In the exemplary case illustrated, the FTV 13 remains in the waiting position at the top pallet changer 9 during the separating machining of the raw sheet metal 21. After the machining has ended, the workpiece pallet 12, now loaded with a sheet metal manufacturing product 22, is moved from the work area of the top laser flatbed machine 1 into the handling position at the top pallet changer 9 and pushed from there onto the FTV 13 located in the waiting position. Together with the workpiece pallet 12 and the sheet metal manufacturing product 22 stored thereby, the FTV 13 travels to the bottom pallet changer 9 (FIG. 2d). In a manner corresponding to the procedures at the top laser flatbed machine 1, the laden workpiece pallet 12 is moved by the FTV 13 firstly into the handling position at the bottom pallet changer 9 and then, for the purpose of carrying out subsequent separating machining of the sheet metal manufacturing product 22, from the handling position at the bottom pallet changer 9 into the manufacturing position in the work area of the bottom laser flatbed machine 1.

After the machining has ended at the bottom laser flatbed machine 1, the workpiece pallet 12 loaded with a sheet metal manufacturing end product 23 is moved from the work area of the bottom laser flatbed machine 1 into the handling position at the bottom pallet changer 9 (FIG. 2e) and transferred from there onto the FTV 13 arranged in the waiting position at the bottom pallet changer 9. Lastly, the workpiece pallet 12 loaded with the sheet metal manufacturing end product 23 is transferred by means of the FTV 13 to an unloading station, not illustrated in FIGS. 2a to 2e, where the sheet metal manufacturing end product 23 is removed from the workpiece pallet 12 and, for the purpose of being transported away from the vicinity of the machine arrangement I, transferred to a transporting means provided for this.

The FTV 13 transfers the now unladen workpiece pallet 12 back to the loading unit 6 and from there directly into a loading position. In the loading position, the workpiece pallet 12 is loaded with further raw sheet metal 21 by the loading unit 6. Then, the further raw sheet metal 21 runs through the manufacturing process described above.

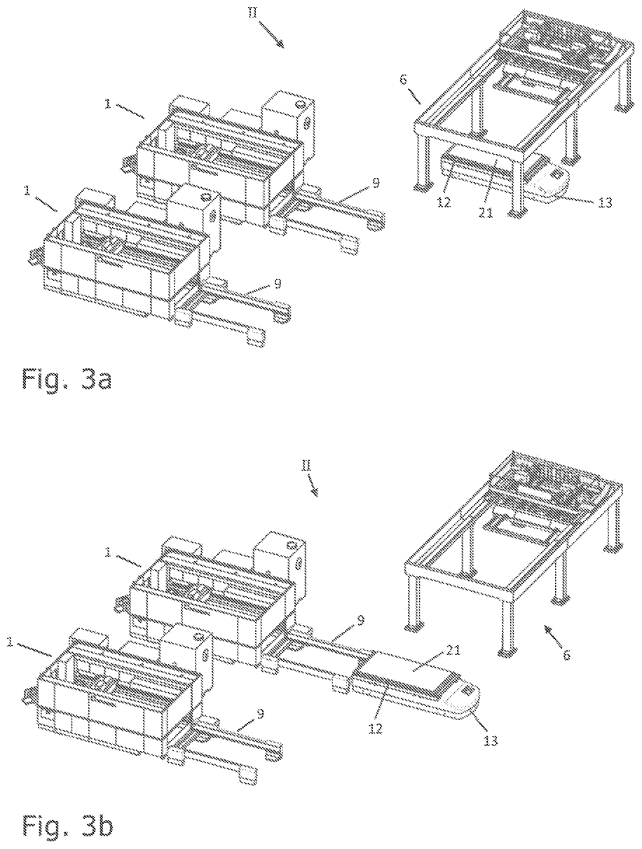

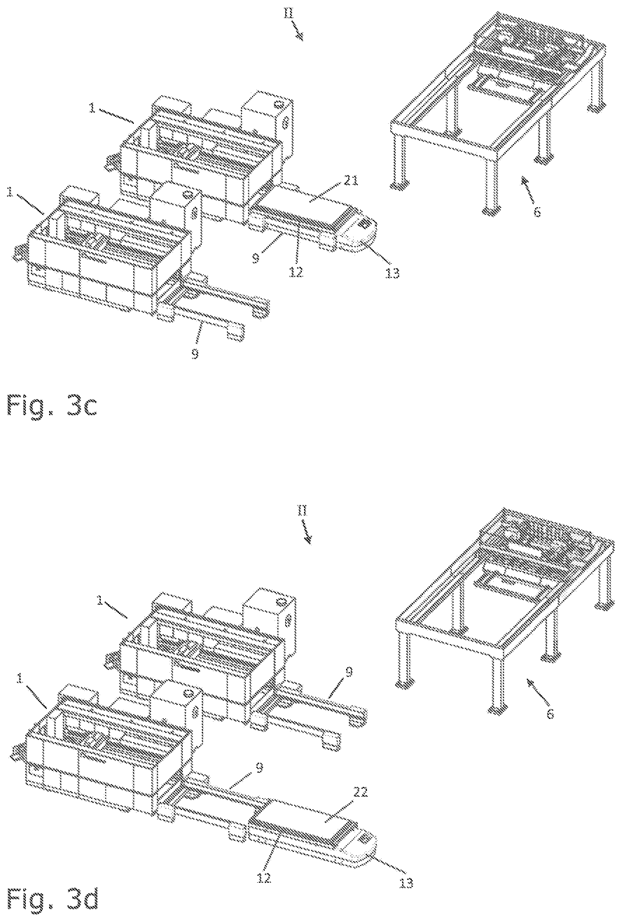

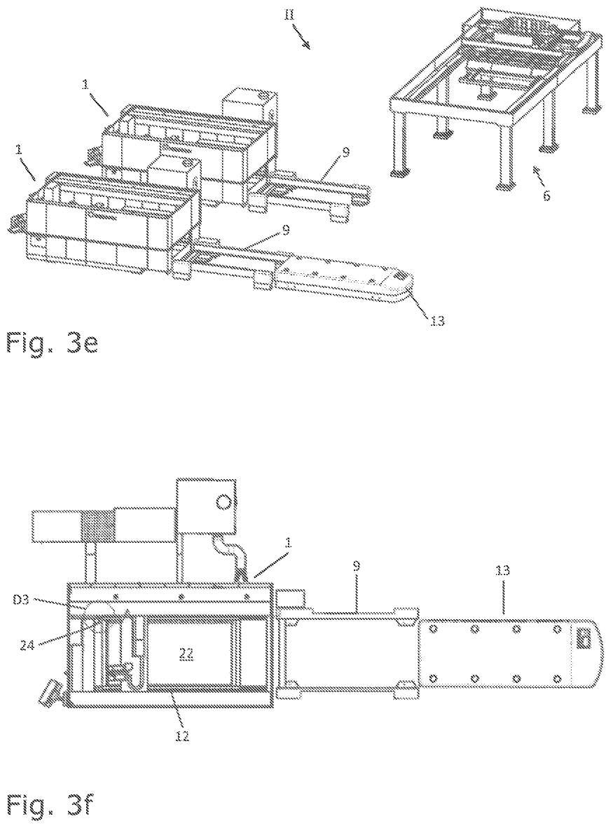

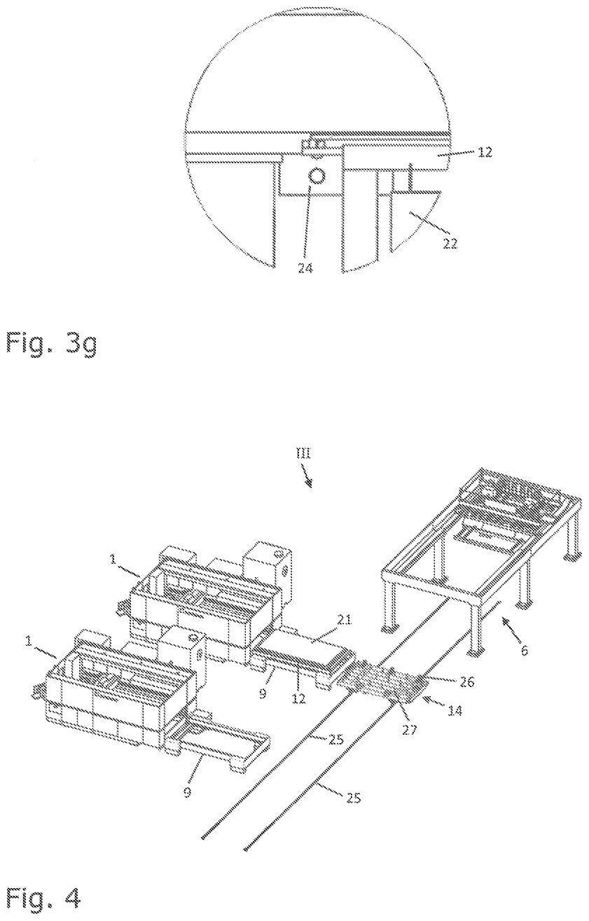

The interconnection of the functional units of a machine arrangement II, illustrated in FIGS. 3a to 3g, for manufacturing sheet metal and the procedures resulting from this interconnection correspond fundamentally to the relationships of the machine arrangement I according to FIGS. 2a to 2e.

As a departure from the machine arrangement I according to FIGS. 2a to 2e, the machine arrangement II according to FIGS. 3a to 3g has two pallet changers 9, on which the workpiece pallet 12 loaded with raw sheet metal 21 can be transferred directly into the handling position by the FTV 13. For this purpose, the frame structure of the pallet changers 9 according to FIGS. 3a to 3g is open on the side remote from the laser flatbed machines 1 and the FTV 13 moves, together with the laden workpiece pallet 12, into the respective pallet changer 9 in the manner illustrated for the top pallet changer 9 in FIG. 3c.

In all other respects, with regard to the procedures depicted in FIGS. 3a to 3d reference can be made to the description above in relation to FIGS. 2a to 2d.

FIG. 3d shows the FTV 13, together with the workpiece pallet 12 and the sheet metal manufacturing product 22 stored thereby, immediately before the workpiece pallet 12 reaches the handling position at the bottom pallet changer 9. As a departure from the procedures of the machine arrangement I according to FIGS. 2a to 2e, when transferring the workpiece pallet 12 to the bottom pallet changer 9 the FTV 13 moves into the bottom pallet changer 9. The workpiece pallet 12 is located directly in the handling position on the FTV 13 that has moved into the bottom pallet changer 9.

FIG. 3e illustrates the machine arrangement II after the workpiece pallet 12, loaded with the sheet metal manufacturing product 22, has been transferred from the handling position at the bottom pallet changer 9 into the manufacturing position in the work area of the bottom laser flatbed machine 1. The FTV 13, from which the workpiece pallet 12 and the sheet metal manufacturing product 22 have been unloaded, is located in a waiting position outside the bottom pallet changer 9. In the meantime, the sheet metal manufacturing product 22, produced beforehand on the top laser flatbed machine 1 and now located in the work area of the bottom laser flatbed machine 1, is subjected to separating machining by the laser cutting head of the bottom laser flatbed machine 1.

FIG. 3f shows a plan view of the relationships according to FIG. 3e. An indexing apparatus 24 of the conventional type, which is illustrated in an enlarged view in FIG. 3g and serves as positioning device, can be seen in FIG. 3f The workpiece pallet 12 is arranged in the work area of the bottom laser flatbed machine 1 in a defined manner in the manufacturing position and fastened there by means of the indexing apparatus 24. Corresponding indexing apparatuses 24 may be provided on the top laser flatbed machine 1 for the defined arrangement of the workpiece pallet 12 in the manufacturing position and also on the loading unit 6 for the defined arrangement of the workpiece pallet 12 in the loading position.

A machine arrangement III, illustrated in FIG. 4, for manufacturing sheet metal differs from the machine arrangements I and II according to FIGS. 2a to 3g in that, instead of an FTV 13, a rail-bound floor conveyor 14 is provided as transport unit.

The floor conveyor 14 can travel along on guide rails 25 to transfer the workpiece pallet 12.

FIG. 4 shows the machine arrangement III with the floor conveyor 14 arranged in a waiting position in front of the top pallet changer 9. The workpiece pallet 12, loaded with the raw sheet metal 21 to be machined, had been moved beforehand into the handling position at the top pallet changer 9 by the floor conveyor 14. Holding means 26 and positioning devices 27 can be seen on the unladen floor conveyor 14. The holding means 26 serve to detachably fasten the workpiece pallet 12 to the floor conveyor 14. The workpiece pallet 12 is positioned in a defined manner on the floor conveyor 14 by means of the positioning devices 27. Corresponding holding means 26 and positioning devices 27 are also provided on the FTV 13 according to FIGS. 2a to 3g, but are not illustrated in the figures for the sake of simplicity.

The holding means 26 may be in the form, for example, of a stop, an elevation, a depression, a wall, a clamp, a pin or similar structures suitable for detachably fastening the workpiece pallet 12 to the FTV 13 or the floor conveyor 14 and securing it against slipping. The positioning device 27 may be in the form, for example, of a depression, an elevation, a wall, a stop or any device able to align the workpiece on the FTV 13 or the floor conveyor 14 in a predefined position.

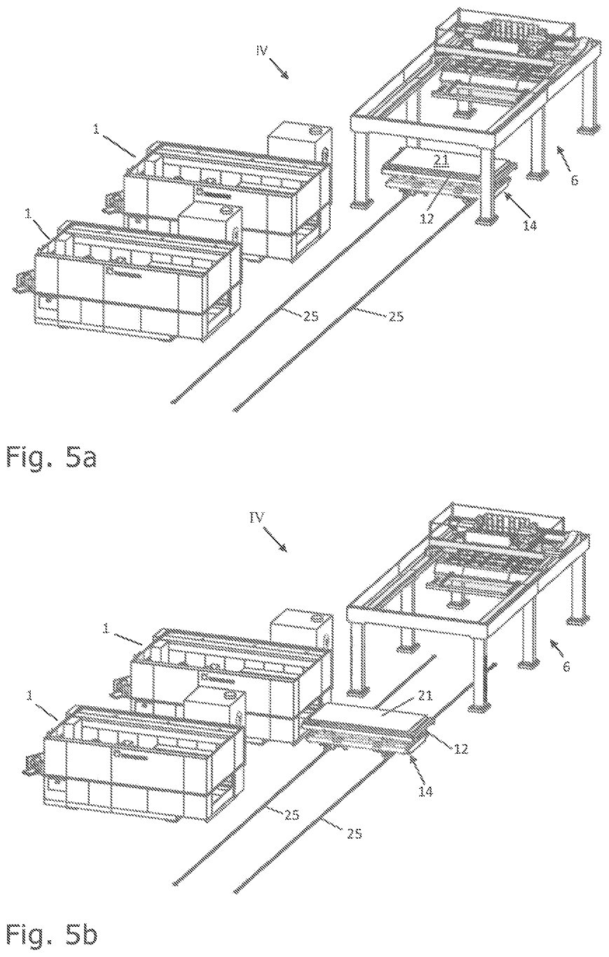

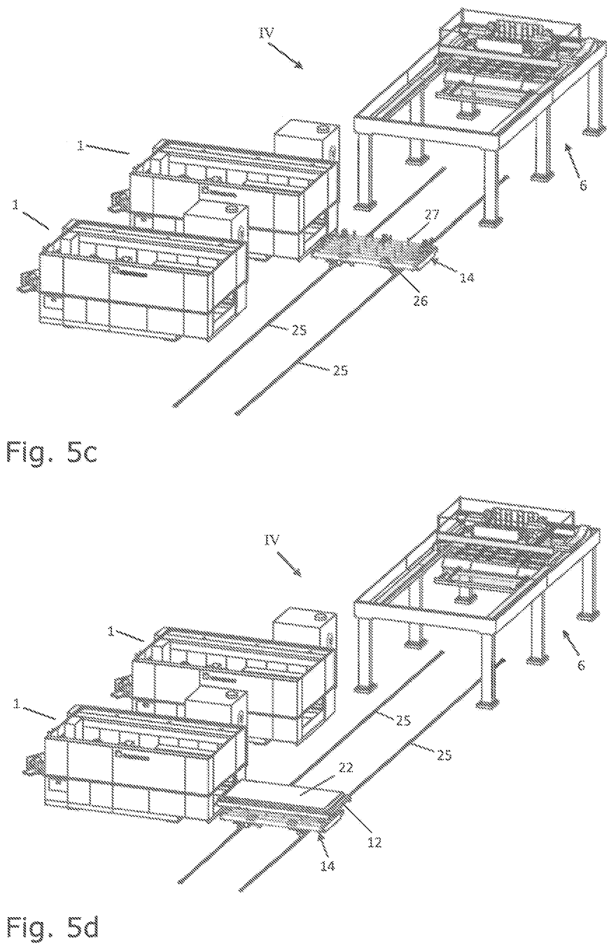

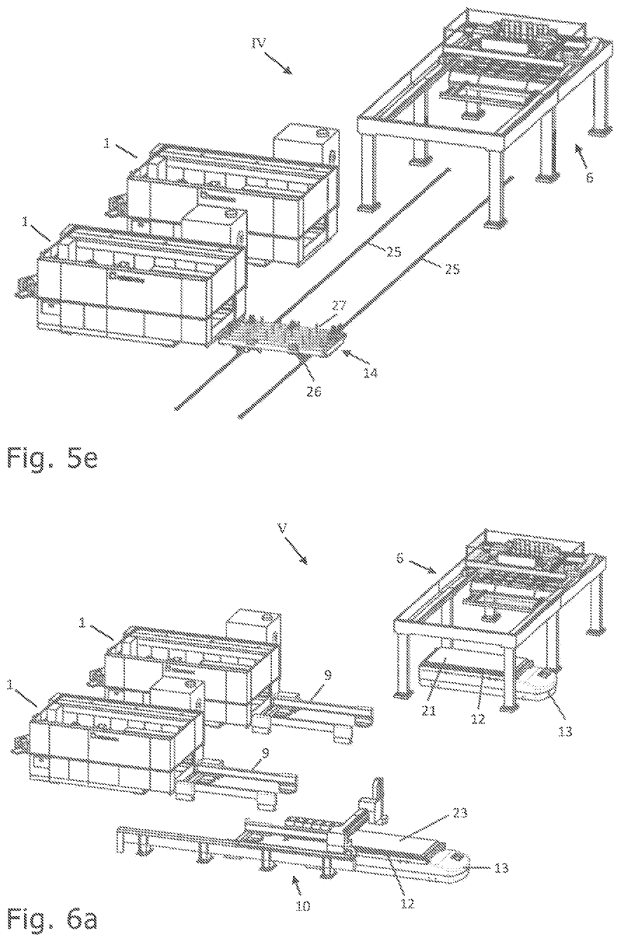

A machine arrangement IV, illustrated in FIGS. 5a to 5e, for manufacturing sheet metal differs from the machine arrangement III according to FIG. 4 merely in that pallet changers 9 of the kind provided on the machine arrangement III are dispensed with. Instead, the workpiece pallet 12 loaded with raw sheet metal 21 or with a sheet metal manufacturing product 22 is transferred directly to the top and to the bottom laser flatbed machine 1 by means of the floor conveyor 14. FIGS. 5b and 5d show the floor conveyor 14, together with the workpiece pallet 12 and the raw sheet metal 21 stored thereby (FIG. 5b) or together with the workpiece pallet 12 and the sheet metal manufacturing product 22 stored thereby, immediately before the laden workpiece pallet 12 is transferred into the work area of the respective laser flatbed machine 1. In FIG. 5c, the floor conveyor 14, from which the workpiece pallet 12 and the raw sheet metal 21 have been unloaded, is located in the waiting position at the top laser flatbed machine 1. Correspondingly, in FIG. 5e, the floor conveyor 14, from which the workpiece pallet 12 and the sheet metal manufacturing product 22 have been unloaded, assumes a waiting position at the bottom laser flatbed machine 1.

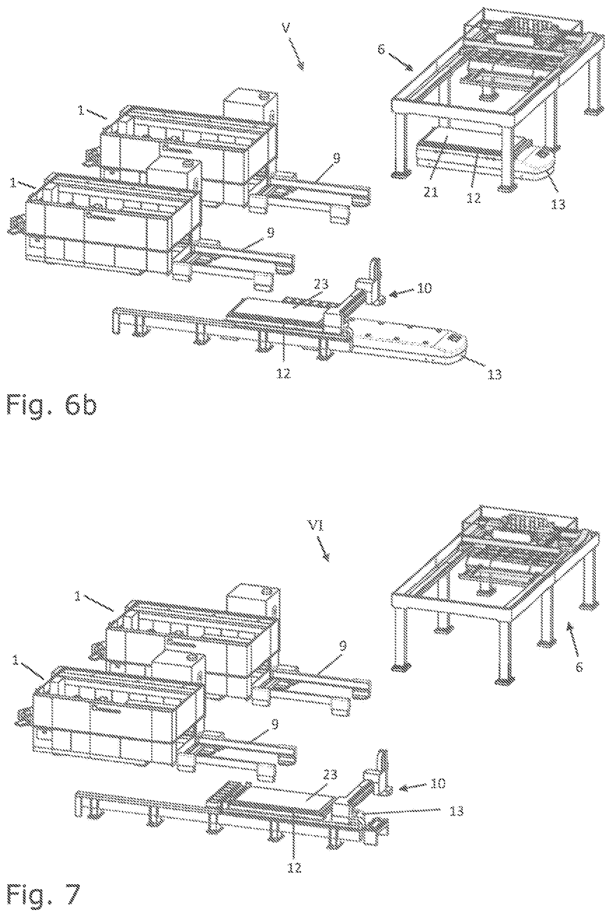

A machine arrangement V for manufacturing sheet metal, as is shown in FIGS. 6a and 6b, in addition to the functional units of the machine arrangements I to IV has, as secondary functional unit, an unloading unit 10 and moreover a further transporting unit in the form of an FTV 13. The unloading unit 10 according to FIGS. 6a, 6b is of the conventional type and is structurally modified with respect to the unloading unit 10 illustrated in FIGS. 1a, 1b to the effect, inter alia, that a suction frame is provided instead of the grille-like receiving apparatus 20 of FIGS. 1a, 1b.

In FIGS. 6a, 6b, one of the FTVs 13 together with a workpiece pallet 12, which for its part has stored on it an end product 23 of the previous sheet metal manufacturing, is arranged at the unloading unit 10. A machining process as was described above in relation to FIGS. 2a to 3g has happened before this.

According to FIG. 6a, the FTV 13 that is at the bottom in the figures has transferred the workpiece pallet 12 and the sheet metal manufacturing end product 23 stored thereby into a position at the unloading unit 10 from which the workpiece pallet 12, together with the sheet metal manufacturing end product 23, is moved into the unloading position at the unloading unit 10 by the FTV 13 using a conventional mechanical apparatus. The workpiece pallet 12 loaded with the sheet metal manufacturing end product 23 is illustrated in the unloading position in FIG. 6b. The sheet metal manufacturing end product 23 is unloaded by means of the unloading unit 10 from the workpiece pallet 12 arranged in the unloading position.

During the unloading operation at the unloading unit 10, the second FTV 13 is located at the loading unit 6 in a position in which the workpiece pallet 12 stored by the FTV 13 assumes a loading position. In FIGS. 6a, 6b, the loading operation of the workpiece pallet 12 at the loading unit 6 has finished. While at the unloading unit 10 the workpiece pallet 12 arranged in the unloading position there has the sheet metal manufacturing end product 23 unloaded from it, the further FTV 13 can transfer the workpiece pallet 12 stored thereby, together with the raw sheet metal 21, to the top laser flatbed machine 1 and transfer the sheet metal manufacturing product 22 produced on the top laser flatbed machine 1 to the bottom laser flatbed machine 1 for machining purposes.

The unloading operation at the unloading unit 10 can be synchronized with manufacturing operations on the laser flatbed machines 1 in this way.

A machine arrangement VI, illustrated in FIG. 7, for manufacturing sheet metal differs from the machine arrangement V according to FIGS. 6a, 6b in terms of the configuration of the unloading unit 10. As a departure from the relationships in the case of the machine arrangement V, the unloading unit 10 according to FIG. 7 is configured in such a way that the FTV 13 can transfer the workpiece pallet 12 together with the sheet metal manufacturing end product 23 directly into the unloading position at the unloading unit 10. The machine arrangement VI is shown with the workpiece pallet 12 arranged in the unloading position on the FTV 13 in FIG. 7.

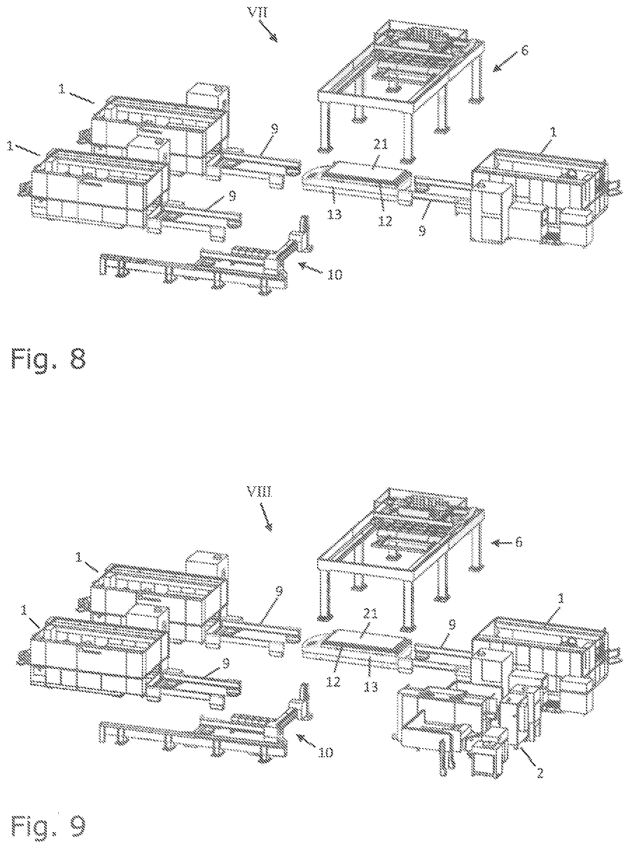

A machine arrangement VII, illustrated in FIG. 8, for manufacturing sheet metal and a machine arrangement VIII, illustrated in FIG. 9, for manufacturing sheet metal differ from the machine arrangement VI according to FIG. 7 by virtue of additional functional units. The machine arrangement VII according to FIG. 8 has, as additional manufacturing unit, a further laser flatbed machine 1 and, as additional secondary functional unit, a further pallet changer 9 assigned to the further laser flatbed machine 1. The machine arrangement VIII according to FIG. 9 has an added combined punching and laser machine 2 over the machine arrangement VII according to FIG. 8.

In all other respects, the procedures on the machine arrangement VII according to FIG. 8 and on the machine arrangement VIII according to FIG. 9 correspond to the procedures on the machine arrangement VI according to FIG. 7.

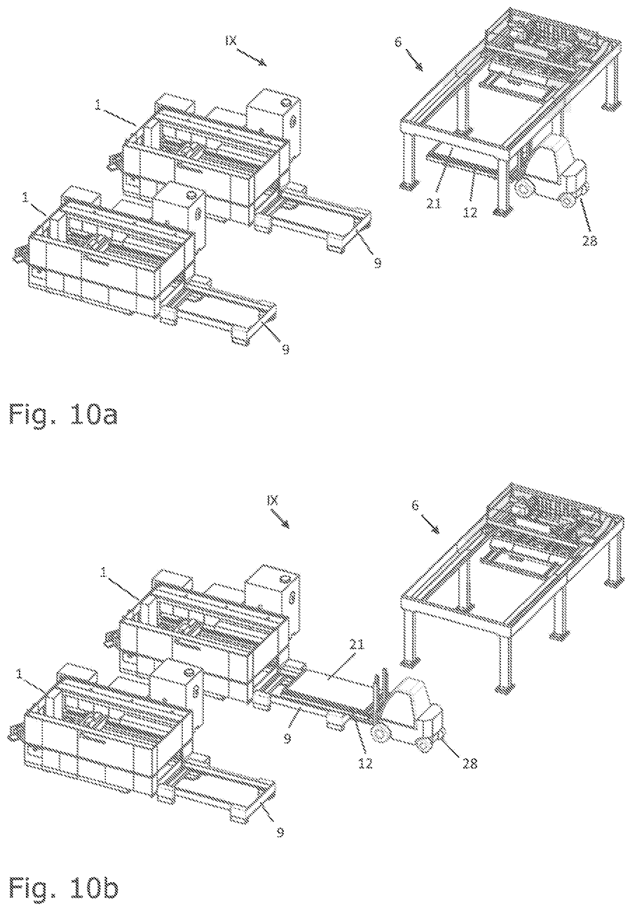

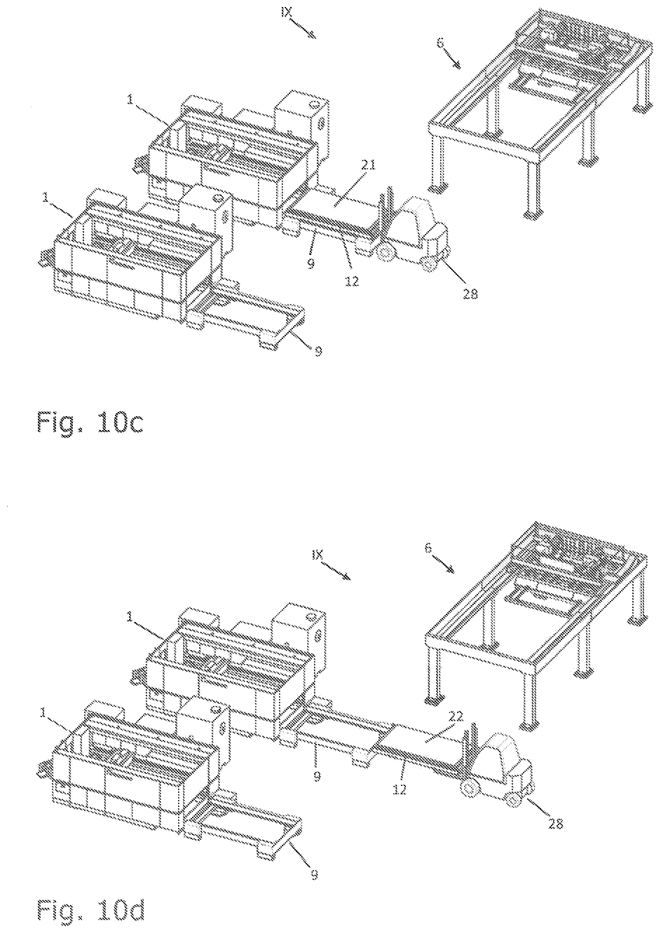

A machine arrangement IX, illustrated in FIGS. 10a to 10d, for manufacturing sheet metal differs from the machine arrangement I according to FIGS. 2a to 2e merely in that, instead of an FTV 13, a manned forklift truck 28 is provided as transporting unit, and in that, by means of the forklift truck 28, the workpiece pallet 12 is transferred directly into the handling position at the pallet changers 9 of laser flatbed machines 1 before the manufacturing process, and received directly in the handling position after the manufacturing process.

In FIG. 10a, the loading unit 6 has loaded the workpiece pallet 12 with raw sheet metal 21. The forklift truck 28 takes up the workpiece pallet 12 in its loading position. FIG. 10b shows the machine arrangement IX while the workpiece pallet 12, loaded with the raw sheet metal 21, is being transferred into the handling position at the top pallet changer 9 by the forklift truck 28. The workpiece pallet 12 and the raw sheet metal 21 are shown in FIG. 10c in the handling position at the top pallet changer 9.

Taking the relationships according to FIG. 10c as a starting point, the laden workpiece pallet 12 is moved out of the handling position at the top pallet changer 9 into the manufacturing position in the work area of the top laser flatbed machine 1, where the separating machining of the raw sheet metal 21 is carried out.

During the separating machining of the raw sheet metal 21, the forklift truck 28 remains in a waiting position at the top pallet changer 9. After the machining has ended, the workpiece pallet 12, now loaded with the sheet metal manufacturing product 22, is moved from the work area of the top laser flatbed machine 1 into the handling position at the top pallet changer 9 and received directly in the handling position by the forklift truck 28. Together with the workpiece pallet 12 and the sheet metal manufacturing product 22 stored thereby, the forklift truck 28 travels from the top pallet changer 9 (FIG. 10d) to the bottom pallet changer 9, where the laden workpiece pallet 12 is arranged directly in the handling position by the forklift truck 28. The workpiece pallet 12, loaded with the sheet metal manufacturing product 22, is then transferred from the handling position into the manufacturing position in the work area of the bottom laser flatbed machine 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A machine arrangement for manufacturing sheet metal, the machine arrangement comprising:
a workpiece carrier configured to store a sheet metal workpiece and/or to store a sheet metal manufacturing product, and
three spatially separate functional units,
wherein the functional units comprise two manufacturing units and a secondary functional unit,
wherein each manufacturing unit comprises a manufacturing apparatus configured to manufacture the sheet metal and has a work area, wherein the workpiece carrier is arrangeable in the work area in a manufacturing position, and wherein the sheet metal workpiece is accessible by the manufacturing apparatus to manufacture the sheet metal, and
wherein the secondary functional unit is not configured to manufacture the sheet metal and has a functional area, wherein the workpiece carrier is arrangeable in the functional area in a functional position,
and the machine arrangement further comprising:
a transporting unit movable in a driven manner together with the workpiece carrier between the functional units, thereby enabling the workpiece carrier to be transferred between the functional units by the transporting unit,
wherein the workpiece carrier is a universal workpiece carrier arrangeable at the two manufacturing units in the manufacturing position and at the secondary functional unit in the functional position.

2. The machine arrangement according to claim 1, wherein the universal workpiece carrier is transferrable between at least one of the manufacturing units, on the one hand, and the secondary functional unit, on the other hand, by the transporting unit.

3. The machine arrangement according to claim 1, wherein the functional units comprise at least one further manufacturing unit.

4. The machine arrangement according to claim 3, wherein the universal workpiece carrier is arrangeable at the further manufacturing unit(s) in the manufacturing position.

5. The machine arrangement according to claim 1, wherein the functional units comprise at least one further secondary functional unit.

6. The machine arrangement according to claim 5, wherein the universal workpiece carrier is arrangeable at the further secondary functional unit(s) in the functional position.

7. The machine arrangement according to claim 1, wherein the universal workpiece carrier is transferrable between the manufacturing units by the transporting unit.

8. The machine arrangement according to claim 5, wherein the universal workpiece carrier is transferrable between the secondary functional units by the transporting unit.

9. The machine arrangement according to claim 5, wherein the universal workpiece carrier is transferrable between at least one of the manufacturing units, on the one hand, and at least one of the secondary functional units, on the other hand, by the transporting unit.

10. The machine arrangement according to claim 1, wherein
the secondary function unit comprises a charging unit, wherein the universal workpiece carrier is transferrable from a position outside the work area of the manufacturing apparatus of one of the manufacturing units into the manufacturing position,
the charging unit has a charging position as the function position of the universal workpiece carrier, wherein the universal workpiece carrier loaded with the sheet metal workpiece is movable from the charging position into the manufacturing position, and the universal workpiece carrier loaded with the sheet metal manufacturing product is movable from the manufacturing position into the charging position, and
the functional units the universal workpiece carrier is transferrable between the charging unit of the manufacturing unit, on the one hand, and another manufacturing unit and/or another secondary functional unit, on the other hand, by the transporting unit.

11. The machine arrangement according to claim 1, wherein, the secondary functional unit comprises:
a loading unit having a loading position as the functional position of the universal workpiece carrier, wherein the universal workpiece carrier is capable of being loaded at the loading position with the sheet metal workpiece that is to undergo a manufacturing operation, and/or
an unloading unit having an unloading position as the functional position of the universal workpiece carrier, wherein the universal workpiece carrier is capable of being unloaded therefrom the sheet metal workpiece and/or the sheet metal manufacturing product, and/or
a storage unit having a storage position as the functional position of the universal workpiece carrier, wherein the universal workpiece carrier is storable, together with the sheet metal workpiece stored by the universal workpiece carrier, and/or together with the sheet metal manufacturing product stored by the universal workpiece carrier, and/or
a store-side handling unit having a handling position as the functional position of the universal workpiece carrier, wherein the universal workpiece carrier is placeable from the handling position into storage in a store or is removable from storage in the store into the handling position, and/or
a cleaning unit having a cleaning position as the functional position of the universal workpiece carrier, wherein the universal workpiece carrier is accessible at the cleaning position for a cleaning apparatus, and/or
a maintenance and/or repair unit having a maintenance position and/or repair position as the functional position of the universal workpiece carrier, wherein maintenance and/or repair work is capable of being carried out on the universal workpiece carrier at the maintenance position and/or repair position, and/or
an equipping unit having an equipping position as the functional position of the universal workpiece carrier, wherein the universal workpiece carrier is configured for a subsequent operation on one of the manufacturing units, and/or
a supply unit having a supply position as the functional position of the universal workpiece carrier, wherein the universal workpiece carrier is suppliable at the supply position for use in the machine arrangement, and/or
a process preparation and/or process follow-up unit having a process preparation position and/or a process follow-up position as the functional position of the universal workpiece carrier, wherein the sheet metal workpiece stored by the universal workpiece carrier is capable of being prepared at the process preparation position for manufacturing the sheet metal, and/or a sheet metal manufacturing operation is capable of being followed up on the sheet metal manufacturing product stored by the universal workpiece carrier at the process followed up position.

12. The machine arrangement according to claim 1, wherein
the transporting unit is movable on rails or
the transporting unit is movable freely.

13. The machine arrangement according to claim 1, wherein
the transporting unit comprises a driverless transporting unit and/or
the transporting unit comprises a driverless transport vehicle.

14. The machine arrangement according to claim 1, wherein
the transporting unit comprises a holding element configured to detachably secure the universal workpiece carrier to the transporting unit, and
the universal workpiece carrier detached from the transporting unit is transferrable between the transporting unit, on the one hand, and the manufacturing position in the work area of at least one of the manufacturing units and/or the functional position in the functional area of at least one of the secondary functional units, on the other hand.

15. The machine arrangement according to claim 14, further comprising a positioning device disposed on the transporting unit and/or on the universal workpiece carrier, wherein the positioning device is configured to arrange the universal workpiece carrier in a defined manner on the transporting unit.

16. The machine arrangement according to claim 1, further comprising
a positioning device, wherein the positioning device is disposed in the work area of at least one of the manufacturing units and/or on the universal workpiece carrier, and the positioning device is configured to arrange the universal workpiece carrier in the working area of the manufacturing unit in a defined manner in the manufacturing position, and/or
wherein the positioning device is disposed in the functional area of at least one of the secondary functional units, on the one hand, and/or on the universal workpiece carrier, on the other hand, and the positioning device is configured to arrange the universal workpiece carrier in the functional area of at least one of secondary functional units in a defined manner in the functional position.

17. The machine arrangement according to claim 1, wherein
at least one of the manufacturing units comprises a laser manufacturing unit having a laser manufacturing apparatus as the manufacturing apparatus for manufacturing the sheet metal, and/or
at least one of the manufacturing units comprises a shaping unit having a shaping apparatus as the manufacturing apparatus for manufacturing the sheet metal, and/or
at least one of the manufacturing units) is in the form of comprises a separating unit having a separating apparatus as the manufacturing apparatus for manufacturing the sheet metal, and/or
at least one of the manufacturing units comprises a joining unit having a joining apparatus as the manufacturing apparatus for manufacturing the sheet metal, and/or
at least one of the manufacturing units comprises a coating unit having a coating apparatus as the manufacturing apparatus for manufacturing the sheet metal.

18. A mechanical method for manufacturing sheet metal, the method comprising:
moving a transporting unit in a driven manner between spatially separate functional units of a machine arrangement for manufacturing a sheet metal, wherein the transporting unit has a workpiece carrier configured to store a sheet metal workpiece and/or to store a sheet metal manufacturing product, and
transferring the workpiece carrier between the functional units,
wherein, the functional units of the machine arrangement comprise two manufacturing units and a secondary functional unit,
wherein the two manufacturing units are configured to manufacture the sheet metal, each manufacturing unit having a work area, wherein the workpiece carrier is arrangeable in the work area in a manufacturing position, and wherein the sheet metal workpiece stored by the workpiece carrier arranged in the manufacturing position is accessible by the manufacturing apparatus to manufacture the sheet metal, and
wherein the secondary functional unit is not configured to manufacture the sheet metal and has a functional area, wherein the workpiece carrier is arranged in the functional area at a functional position,
wherein
the workpiece carrier is a universal workpiece carrier arrangeable at the two manufacturing units in the manufacturing position and at the secondary functional unit in the functional position, and
the universal workpiece carrier is transferrable between the functional units by the transporting unit.

19. A workpiece carrier, in the form of the universal workpiece carrier of the machine arrangement according to claim 1.

20. A transporting unit, in the form of the transporting unit of the machine arrangement according to claim 1.
